(19) United States
(12) Patent Application Publication
(10) Pub. No.: US 2024/0256179 A1
(43) Pub. Date: Aug. 1, 2024

(54) SYSTEMS AND METHODS FOR MANAGING APPLICATION REQUESTS

(71) Applicant: Dell Products L.P., Round Rock, TX (US)

(72) Inventor: Aaron T. Twohig, Rathpeacon (IE)

(73) Assignee: Dell Products L.P., Round Rock, TX (US)

(21) Appl. No.: 18/162,880

(22) Filed: Feb. 1, 2023

(51) Int. Cl. G06F 3/06

(52) U.S. Cl. CPC G06F 3/0659; G06F 3/0604; G06F 3/067

(57) ABSTRACT

According to one aspect, a method includes: receiving a request by an application programming interface (API) of a server device, wherein servicing of the request involves use of one or more resources external to the server; determining, by a filter of the server device, a type of the request; sending, by the filter, the request to a controller selected from a plurality of controllers of the server device based on the request type, where different ones of the plurality of controllers are configured to service different types of API requests; and determining, by the controller, how to handle the request based at least in part upon a rate of recent request traffic received by the controller.

### BACKGROUND

A storage system may include a plurality of storage devices (e.g., storage arrays) to provide data storage to a plurality of nodes. The plurality of storage devices and the plurality of nodes may be situated in the same physical location, or in one or more physically remote locations. The plurality of nodes may be coupled to the storage devices by a high-speed interconnect, such as a switch fabric.

Storage systems and other kinds of client-server computing systems may provide application programming interfaces (APIs) to enable users to access various features thereof. For example, using an API, a storage administrator may retrieve information about a storage group or list of groups, create new storage groups, modify an existing group, or delete a storage group.

REST APIs communicate via Hypertext Transfer Protocol (HTTP) requests to perform standard database functions like creating, reading, updating, and deleting records within a resource. For example, a REST API may use an HTTP GET request to retrieve a record, a POST request to create one, a PUT request to update a record, and a DELETE request to delete one. REST APIs are widely used in client-server computing applications.

### SUMMARY

According to one aspect of the disclosure, a method includes: receiving a request by an application programming interface (API) of a server device, wherein servicing of the request involves use of one or more resources external to the server; determining, by a filter of the server device, a type of the request; sending, by the filter, the request to a controller selected from a plurality of controllers of the server device based on the request type, where different ones of the plurality of controllers are configured to service different types of API requests; and determining, by the controller, how to handle the request based at least in part upon a rate of recent request traffic received by the controller. The controller can decide to service the request, enqueue the request, or reject the request.

In some embodiments, the receiving of the request may include enqueuing the request in a first queue, and the determining of how to handle the request can include enqueuing the request in a second request queue of the controller. In some embodiments, the determining of how to handle the request can include assigning the request to a thread of the controller. In some embodiments, the controller may be configured to have a maximum number of threads for servicing requests and a maximum number of threads for enqueuing threads. In some embodiments, another controller of the plurality can have a maximum number of threads for servicing requests different from that of the controller. In some embodiments, the server device may be part of a storage system. In some embodiments, the server device may be part of a storage array.

According to another aspect of the disclosure, an apparatus includes a processor a non-volatile memory storing computer program code. The computer program code, when executed on the processor causes the processor to execute a process corresponding to any of the aforementioned method embodiments.

According to another aspect of the disclosure, a non-transitory machine-readable medium encodes instructions that when executed by one or more processors cause a process to be carried out. The process can correspond to any of the aforementioned method embodiments.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

### BRIEF DESCRIPTION OF THE DRAWINGS

The manner of making and using the disclosed subject matter may be appreciated by reference to the detailed description in connection with the drawings, in which like reference numerals identify like elements.

FIG. 1 is a block diagram of an illustrative storage system within which embodiments of the present disclosure may be utilized.

FIG. 2 is a block diagram of a client-server system in which API requests are serviced on a first come, first serve basis.

FIG. 3 is a block diagram of a client-server system for managing API requests using multiple independent traffic controllers, according to embodiments of the present disclosure.

FIGS. 4 and 5 are flow diagrams showing processing that can occur within the system of FIG. 3, according to some embodiments.

FIG. 6 is a block diagram of a processing device on which methods and processes disclosed herein can be implemented, according to some embodiments of the disclosure.

The drawings are not necessarily to scale, or inclusive of all elements of a system, emphasis instead generally being placed upon illustrating the concepts, structures, and techniques sought to be protected herein.

### DETAILED DESCRIPTION

An API may be available for use to external applications and customer-written scripts, and thus may receive a high rate of request traffic. In some systems, an API may be hosted on a physical or virtual machine that has limited resources in terms of processing capability, memory, and bandwidth to downstream resources (meaning resources that must be accessed in the course of servicing certain API requests). This is the case in some storage systems, where a management application may run on a single server (e.g., an embedded system packaged with a storage array) while providing API access to various storage-related management tasks, such as configuring new storage devices (or logical unit numbers, LUNs) and obtaining performance data/metrics. In the case of a storage system, downstream resources can include storage arrays, storage devices/LUNs, and other storage-related resources. Other examples of downstream resources include databases (e.g., relationship database management systems) and encrypted repositories for storing passwords, encryption keys, and other sensitive information.

It may be desirable to manage API requests in such a way that optimizes overall request throughput, while maximizing availability and fairness. Various challenges exist to achieving these objectives.

For example, throughput can be negatively affected by attempting to service too many requests concurrently, as downstream resources may achieve better throughput with less concurrency. With higher levels of concurrency, some resources may spend more time switching between requests than servicing them (similar to central processing unit, CPU, thrashing).

As another example, if certain types of requests that take a relatively long time to service (e.g., on the order of multiple seconds or even minutes), these can consume most if not all available resources and unduly delay other requests that could be serviced more quickly (e.g., on the order of milliseconds). In the worst cases, other requests may time out and the system can appear unavailable to the client devices sending those requests. This problem is sometimes referred to as “resource hogging.” To avoid resource hogging, a system can dedicate resources to particular type of request, which is sometimes referred to as “ring fencing.” However, this approach can waste resources when most requests are of the same type: some resources will remain idle while the dedicated resources are all in use and requests are being queued. This can lead to unnecessarily high rates of request rejections and timeouts.

One approach to addressing aforementioned challenges is to rate-limit (or “throttle”) specific types of API requests. For example, for a given type of API request, a maximum rate can be defined (e.g., X requests per second). If a certain type of request is made at a rate exceeding its defined maximum, then some of those requests may be rejected. Existing systems may implement throttling in a rigid manner, not allowing flexibility for intermittent bursts of traffic (i.e., uneven traffic patterns). For example, it may be desirable to allow for more than X requests per second so long as the sustained rate (i.e., the average rate over a predetermined period, such as several seconds or minutes) is not greater than X.

Existing API load balancing solutions involve the use of multiple physical and/or virtual severs. This may not be practical or feasible for certain applications, such as storage management applications designed to run on embedded systems packaged with a storage array. Disclosed herein are structures and techniques for improved management of API requests that can be utilized, for example, within embedded systems and other resource-constrained environments.

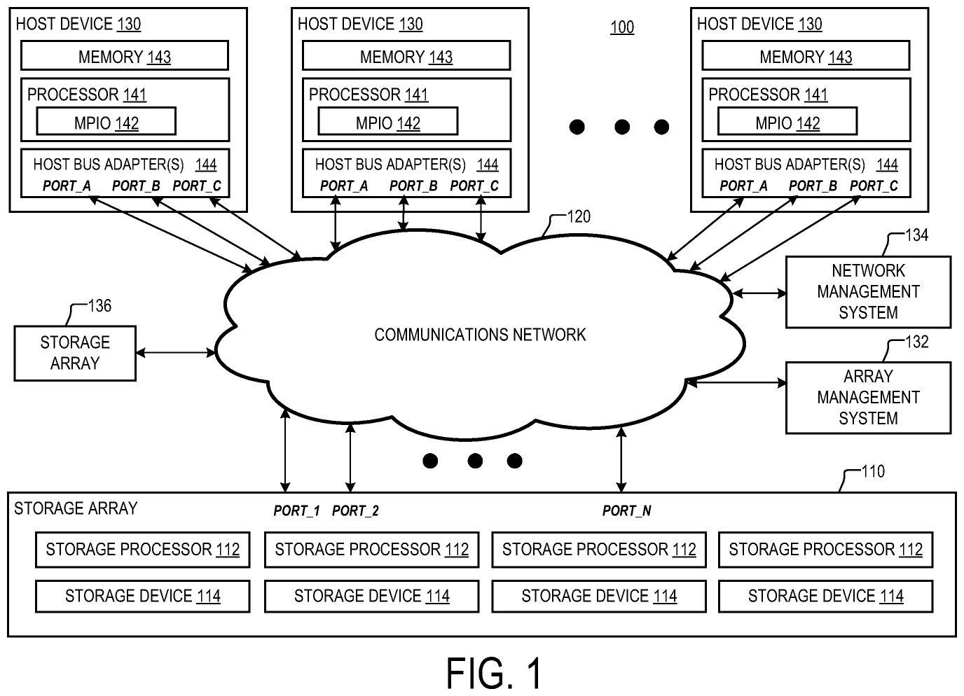

FIG. 1 is a diagram of an example of a storage system 100 within which embodiments of the present disclosure may be utilized. As illustrated, system 100 may include a storage array 110, a communications network 120, a plurality of host devices 130, an array management system 132, a network management system 134, and a storage array 136.

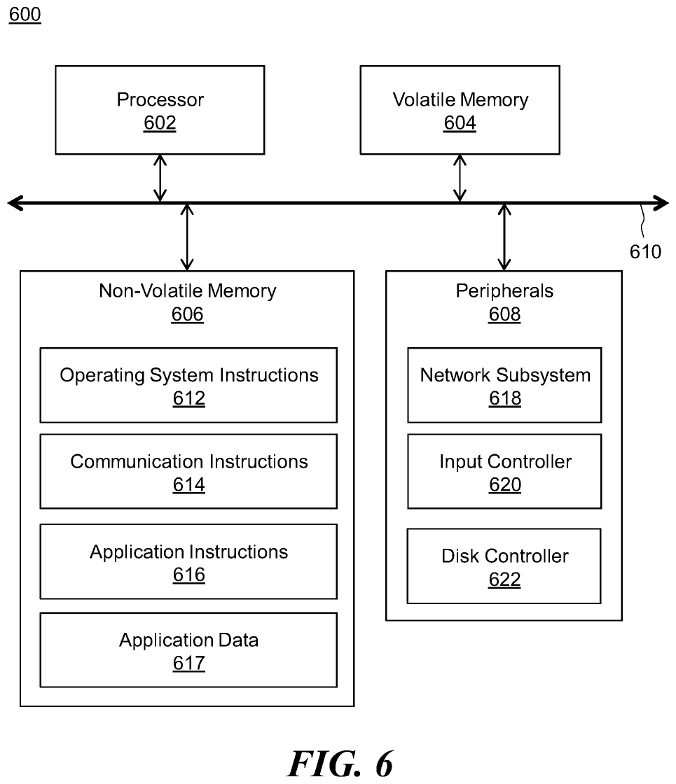

The storage array 110 may include a plurality of storage processors 112 and a plurality of storage devices 114. Each of the storage processors 112 may include a computing device that is configured to receive I/O requests from any of the host devices 130 and execute the received I/O requests by reading or writing data to the storage devices 114. In some implementations, each of the storage processors 112 may have an architecture that is the same or similar to the architecture of the computing device 600 of FIG. 6. The storage processors 112 may be located in the same geographic location or in different geographic locations. Similarly, storage devices 114 may be located in the same geographic location or different geographic locations. Each of the storage devices 114 may include any of a solid-state drive (SSD), a non-volatile random-access memory (nvRAM) device, a non-volatile memory express (NVME) device, a hard disk (HD), and/or any other suitable type of storage device. In some implementations, the storage devices 114 may be arranged in one or more Redundant Array(s) of Independent Disks (RAID) arrays. The communications network 120 may include one or more of the Internet, a local area network (LAN), a wide area network (WAN), a fibre channel (FC) network, and/or any other suitable type of network.

Each of the host devices 130 may include a laptop, a desktop computer, a smartphone, a tablet, an Internet-of-Things device, and/or any other suitable type of electronic device that is configured to retrieve and store data in the storage arrays 110 and 136. Each host device 130 may include a memory 143, a processor 141, and one or more host bus adapters (HBAs) 144. The memory 143 may include any suitable type of volatile and/or non-volatile memory, such as a solid-state drive (SSD), a hard disk (HD), a random-access memory (RAM), a Synchronous Dynamic Random-Access Memory (SDRAM), etc. The processor 141 may include any suitable type of processing circuitry, such as a general-purpose process (e.g., an x86 processor, a MIPS processor, an ARM processor, etc.), a special-purpose processor, an application-specific integrated circuit (ASIC), a field programmable gate array (FPGA), etc. Each of the HBAs 144 may be a circuit board or integrated circuit adapter that connects a respective one of the host devices 130 to the storage array 110 (and/or storage array 136). In other words, each of the HBAs 144 may include a communications interface for connecting to the communications network 120, storage array 110 and/or storage array 136. Although in the example of FIG. 1 each of the host devices 130 is provided with at least one HBA 144, alternative implementations are possible in which the each of the host devices is provided with another type of communications interface, in addition to (or instead of) an HBA. The other type of communications interface may include one or more of an Ethernet adapter, a WiFi adapter, a local area network (LAN) adapter, etc.

Each processor 141 may be configured to execute a multi-path I/O (MPIO) driver 142. The MPIO driver 142 may comprise, for example, PowerPath TM drivers from Dell EMC TM, and/or other types of MPIO drivers that are arranged to discover available communications paths any of the host devices 130 and the storage array 110. The MPIO driver 142 may be configured to select I/O operations from any of the I/O queues of the host devices 130. The sources of the I/O operations stored in the I/O queues may include respective processes of one or more applications executing on the host devices 130.

The HBA 144 of each of the host devices 130 may include one or more ports. Specifically, in the example of FIG. 1, the HBA 144 of each of the host devices 130 includes three ports, which are herein enumerated as “port A”, “port B”, and “port C”. Furthermore, storage array 110 may also include a plurality of ports. In the example of FIG. 1, the ports in the storage array 110 are enumerated as “port 1”, “port 2,” and “port N”, where N is a positive integer greater than 2. Each of the ports in the host devices 130 may be coupled to one of the ports of the storage array via a corresponding network path. The corresponding network path may include one or more hops in the communications network 120. Under the nomenclature of the present disclosure, a network path spanning between an HBA port of one of host devices 130 and one of the ports of the storage array 110 is referred to as a “network path of that host device 130”.

Array management system 132 may include a computing device, such as the computing device 600 of FIG. 6. The array management system 132 may be used by a system administrator to re-configure the storage array 110, e.g., when degraded performance of the storage array 110 is detected.

Network management system 134 may include a computing device, such as the computing device 600 of FIG. 6. The network management system 134 may be used by a network administrator to configure the communications network 120 when degraded performance of the communications network 120 is detected.

The storage array 136 may be the same or similar to the storage array 110. The storage array 136 may be configured to store the same data as the storage array 110. The storage array 136 may be configured to operate in either active-active configuration with the storage array 110 or in active-passive configuration. When storage arrays 110 and 136 operate in active-active configuration, a write request to either of storage arrays 110 and 136 is not acknowledged back to the sender until the data associated with the write request is written to both of the storage arrays 110 and 136. When storage arrays 110 and 136 are operated in active-passive configuration, a write request to a given one of the storage arrays 110 and 136 is acknowledge for as long the data associated with write request is written to the given one of the storage arrays 110 and 136 before the writing to the other one of the storage arrays is completed.

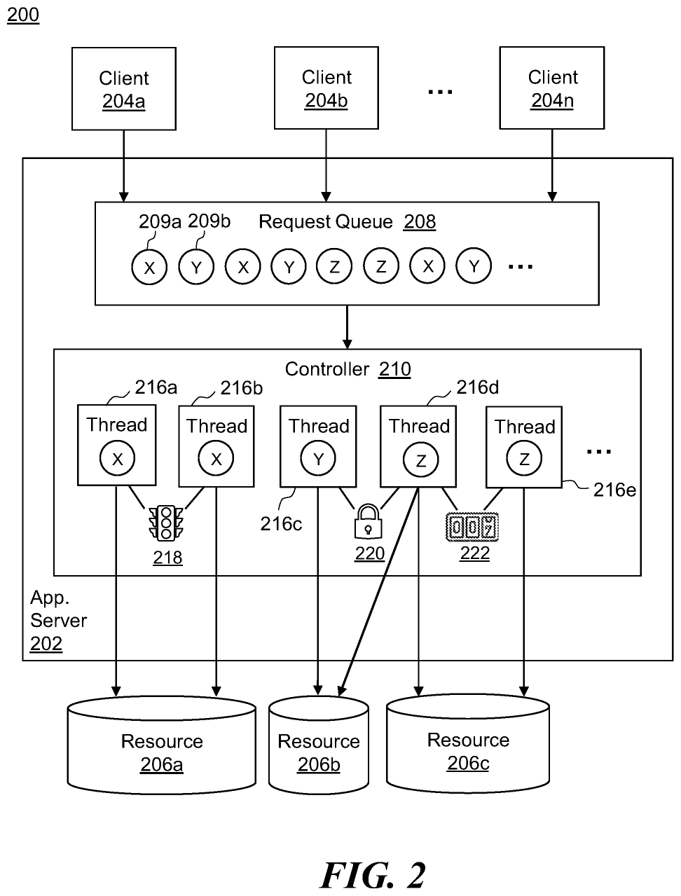

FIG. 2 shows an example of a client-server system 200 in which API requests may be serviced on a first come, first serve basis. One or more client devices 204a, 204b, . . . , 204n (204 generally) can access an application server 202 via one or more communication networks (not shown). The illustrative system 200 can include one or more resources 206a, 206b, . . . , 206n (206 generally) that may be accessed by server 202 via one or more communication networks (also not shown). Said communication networks can include, for example, the Internet, LANs, WANs, FC networks, etc.

Client devices 204 can access functionality of application server 202 via an API provided thereby. In some embodiments, server 202 may provide a REST API. Thus, for example, a client device 204 can make API requests (or “calls”) by sending HTTP requests to server 202 and receiving HTTP responses therefrom. Server 202 can handle such HTTP requests by inspecting the request header information to determine an action being requested (e.g., create, read, update, or delete) and a type of resource for which that action applies (e.g., storage devices/LUNs, storage groups, etc.). In some cases, the action can be determined by the HTTP method (e.g., POST for create, GET for read, PUT for update, or DELETE for delete). In some cases, the type of resource can be determined based on the HTTP request target/path. Both the HTTP method and request target may be specified in the first line (or “start line”) of the HTTP request.

Reference is made herein to a “type” of an API request. This generally refers to a distinct action being requested of the API. For example, in the case of a storage system, an API request to create a storage group may be considered one type of request, whereas an API request to read information about a storage group may be considered a different type of request. As another example, an API request to read information about a LUN may be treated as distinct from an API to read information about a storage volume. Thus, in the case of a REST API, the “type” of a request may correspond to the combination of HTTP request method and target/path. In some cases, the “type” of an API request can be defined in terms of an API endpoint. For example, a GET request with path “/abc” may be treated as a different type than a GET request with path “/def”, which may be treated as a different type than a POST request with path “/def”.

Server 202 can include a request queue 208 for queuing incoming API requests, and a controller 210 for servicing said requests according to application-specific business logic. Server 202 may include various other hardware and software components omitted for clarity. For example, server 202 may include various other computing device components described below in the context of FIG. 6.

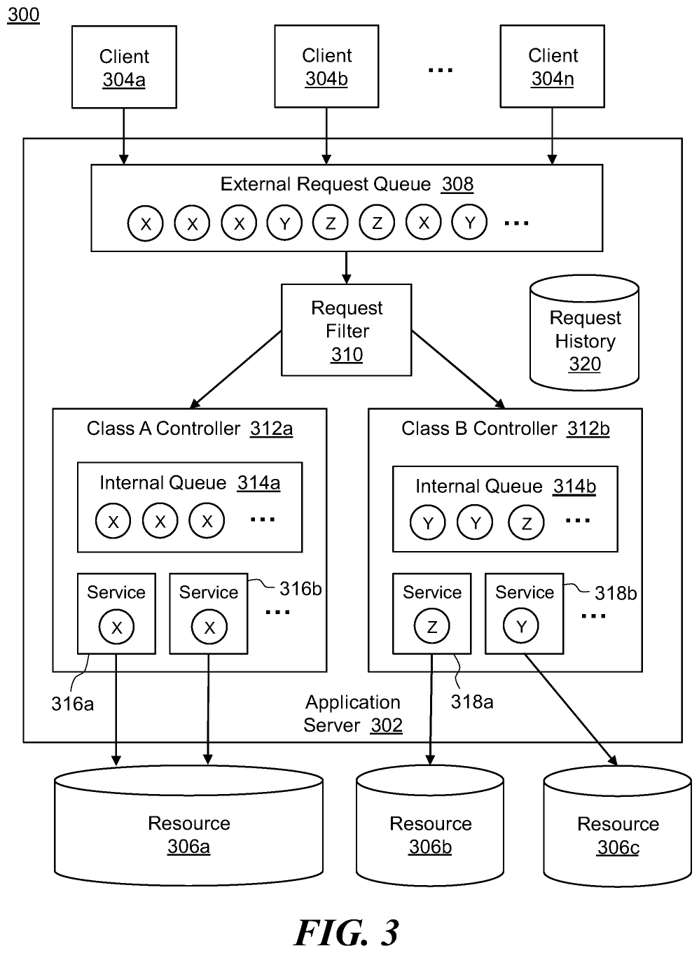

Request queue 208 can be provided as a software component configured to queue arbitrary types of API requests that are received from client devices 204 via or more network interfaces of server 202. In FIGS. 2 and 3, requests are represented as circular elements, and different types of requests are represented using different letters within those circular elements. For example, circular element 209a may represent a first type of request (“X”) whereas circular element 209b may represent a second type of request (“Y”). For clarity, only three types of requests are illustrated in the figures (“X”, “Y”, and “Z”). However, in practice, an API may support tens or even hundreds of different request types.

Request queue 208 may be configured to hold an arbitrary number of requests at a given time and, depending on the request arrival rate and servicing rate, may hold hundreds or even thousands of requests at a time. Within request queue 208, a given request may be represented as a sequence or stream of bytes that were read from a network socket interface or other “low-level” I/O mechanism. Of note, request queue 208 may not differentiate between different types of requests or perform any type of examination of enqueued requests. Thus, there may be no mechanism to practically/efficiently prioritize or reject requests using request queue 208.

Request queue 208 and controller 210 may run within a common application platform that supports multithreading, as JBOSS or another JAVA enterprise application platform. In some embodiments, controller 210 may be part of a Java Enterprise Edition (JEE) application that runs within an application container such as WILDFLY application container. In some embodiments, request queue 208 may be implanted using XNIO, a simplified low-level I/O layer for use with JAVA.

Requests arriving at server 200 are initially placed in the low-level request queue 208. On a first come, first serve basis, API requests can be removed from the head of queue 208 and passed or otherwise made available to controller 210. Controller 210 may be configured to allocate a plurality of threads 216a, 216b, etc. (216 generally) for servicing API requests in parallel, with each thread 216 capable of servicing at most one request at a time. After a request is completed on a given thread 216, controller 210 can obtain another request from the head of the request queue 208 and assign that request to the newly available thread. That is, controller 210 may service API requests on a first come, first serve basis without regard to the amount of time servicing it typically takes to service different types of requests, the type of downstream resources consumed by different types of requests, or other considerations. Thus, as shown in the example of FIG. 2, threads 216a and 216b may both service a request of type “X”, thread 216c may service a request of type “Y”, and threads 216d and 216e may service a request of type “Z”.

The number of allocated threads, T_{alloc}, may be fixed according to a hardcoded value or configuration parameter of controller 210 or the application container in which it run. In some cases, the number of allocated threads may be based on the hardware capabilities/resources of application server 202. In some cases, N threads may be allocated for each CPU core where N=1, 2, 4, 8, 16, etc. For example, on an 8-core machine, a total of one hundred and twenty eight (T_{alloc}=16×8=128) threads may be allocated (assuming N=16).

Once an API request is assigned to a thread 216, controller 210 can examine the request to determine its type, parameters, and other attributes, and then service the request using corresponding request-specific logic provided by the application (e.g., storage management application). At this stage, the request can be either serviced immediately (i.e., its thread can be immediately executed), enqueued (i.e., its thread put into an inactive state), or rejected.

In the course of servicing API requests, a given thread 216 can access one or more downstream resources 206, which can include databases (e.g., relationship database management systems), encrypted repositories, storage arrays, storage devices/LUNs, among various other types of resources. In some cases, threads 216 can coordinate their behavior using semaphores, shared locks, counters, and/or other programming structures usable for controlling access to shared resources. For example, as shown in FIG. 2, threads 216a and 216b may use a semaphore 218 to coordinate access to resource 206a, threads 216c and 216d may use a shared lock 220 to coordinate access to resource 206b, and threads 216d and 216e may use a counter 222 to coordinate access to resource 206c. In some cases, threads 216 can block when accessing shared, downstream resources.

Client-server system 200 just described may fail to optimize overall request throughput while maximizing availability and fairness. For example, throughput can be negatively affected by attempting to service too many requests concurrently (e.g., 128 concurrent requests) as some downstream resources 206 may achieve better throughput with less concurrency. As another example, requests that take a relatively long time to service may end up consuming most if not all available resources, thereby (unfairly) delaying other types of requests.

Turning to FIG. 3, as a solution to these and other problems, embodiments of the present can filter API requests into multiple distinct classes (e.g., based on request types and/or other attributes) and utilize separate controllers and thread resources to service different classes of requests. This allows for more flexible use of resources. For example, requests that require access to certain downstream resources may be designated within one class, whereas requests that require access to other downstream resources may be designated within another class. In some embodiments, prioritization policies can be varied according to conditions and throttling can be selectively used to increase, and ideally optimize, throughput. In some embodiments, different numbers of threads may be allocated for servicing different classes of requests. In some embodiments, unused threads allocated to one class of requests may be “borrowed” to service another class of requests on a conditional basis, so as to accommodate bursts of traffic while avoiding resource hogging. Using the disclosed structures and techniques, different types/classes of requests may be rate-limited (“throttled”) only as needed, based on system and downstream resource conditions.

An illustrative client-server system 300 includes an application server 302, client devices 304a, 304b, . . . , 304n (304 generally), and one or more downstream resources 306a, 306b, . . . , 306n (306 generally). Client devices 304 can send various types of API requests to application server 302. Application server 302 can include a request queue 308 to queue these arriving API requests, and this so-called “external” request queue 308 may be similar in function and structure to request queue 208 of FIG. 2. For example, external request queue 308 may also be configured to queue large numbers of arriving API requests without differentiating between different types of requests or performing any type of examination of enqueued requests.

In some embodiments, client-server system 300 may be provided as part of (e.g., embedded within) a storage system. For example, application server 302 may be associated with array management system 132 of FIG. 1 and downstream resources 306 may correspond to storage arrays 110, 136 of FIG. 1. Of note, management system 132 of FIG. 1 can be physically embedded within array 110 to manage storage resources therein and, in some cases, to also manage storage resources of other arrays (e.g., array 136) via a communications network.

Application server 302 also includes a request filter 310 and a plurality of request controllers 312a, 312b (312 generally), which components 310, 312 may be provided as software components configured to perform the functions described herein. Request filter 310 can examine API requests (e.g., by reading and processing HTTP request headers) within external request queue 308 to classify them according to one or more criteria, and then pass requests to particular request controllers 312 according to their classifications. For example, request filter 310 may be configured to classify requests based on their expected completion durations and/or the particular downstream resources 306 involved in servicing the requests. As a more specific example, requests that are expected to complete quickly (e.g., within a few milliseconds) and/or consume few resources may be designated as one class, whereas requests expected to complete more slowly (e.g., take one or more seconds to handle) and/or consume more resources may be designated as another class. In the case of a storage management application, requests to obtain storage performance data (i.e., metrics) may be designated as a different class from requests to read or write configuration data, for example. In some embodiments, request filter 310 may classify requests using a mapping of request types to request classes. Said mapping can be maintained, for example, in a configuration file or database accessible to application server 302. In this way, requests can readily be re-classified to optimize throughput or achieve other operational objectives.

Request filter 310 may extract and examine requests from external request queue 308 on a first come, first serve basis. For example, on a periodic, continuous, or interrupt-driven basis, request filter 310 may extract a request from the head of queue 308, examine the request to determine which class it belongs to, and then pass the request to a corresponding one of the request controllers 312. In some cases, request filter 310 may take requests from the head of external queue 308 as threads become free.

In some embodiments, external request queue 308, request filter 310, and the plurality of request controllers 312 may all run within a common application platform that supports multithreading, as JBOSS or another JAVA enterprise application platform. In some embodiments, controller 210 may be part of a Java Enterprise Edition (JEE) application that runs within an application container such as WILDFLY application container. Application server 302 (or the application container) may be configured to allocate a maximum total number of threads, T_{alloc}, for use by all of the components 308, 310, 312.

Request controllers 312 can include internal request queues and threads for servicing API requests in parallel. For example, a first request controller 312a can include internal request queue 314a and servicing threads 316a, 316b, etc. (316 generally), and a second request controller 312b can include internal request queue 314b and servicing threads 318a, 318b, etc. (318 generally). In the course of service API requests, a given servicing thread 316, 318 can access one or more downstream resources 306, which can include databases (e.g., relationship database management systems), encrypted repositories, storage arrays, storage devices/LUNs, among various other types of resources. A given request controller 312 can also include request-specific business logic for processing the types of API requests passed thereto. Similar to the threads in FIG. 2, servicing threads 316 and/or servicing threads 318 can coordinate their behavior using semaphores, shared locks, counters, and/or other programming structures usable for controlling access to a common resource. For clarity, such structures are not shown in FIG. 3.

In the example of FIG. 3, it is assumed that requests of type “X” are designated as class “A” and requests of types “Y” and “Z” are designated as class “B”. It is also assumed that first request controller 312a services class “A” requests and that second request controller 312b services class “B” requests. Thus, as shown in the figure, internal queue 314a of first request controller 312a holds requests of type “X” and servicing threads 316 of first request controller 312a service requests of type “X”. As also shown, internal queue 314b of second request controller 312b holds requests of types “Y” and “Z” and threads 318 of second request controller 312b service requests of types “Y” and “Z”.

Within a given request controller 312, all requests can be assigned to their own thread, including requests held in the internal queue 314 and requests actively being serviced (i.e., requests assigned to servicing threads 316 or 318). For a given request controller 312, the maximum number of requests that can be concurrently serviced, Eₘₐₓ, and the maximum number of enqueued requests, Qₘₐₓ, may be determined according to configuration settings (e.g., settings stored within a configuration file or database), and different values may be used for different classes of requests. For example, class “A” request controller 312a may be configured to allow up to fifty requests to be serviced in parallel and up to sixty requests to be enqueued at a time (E_{max_A}=50, Q_{max_A}=60), whereas class “B” request controller 312b may be allow up to eight requests to be serviced in parallel and up to ten requests to be enqueued at a time (E_{max_B}=8, Q_{max_B}=10). In some cases, the sum the threads allocated to request controllers 312 may equal to (or approximately equal to) the total number of threads allocated by application server 302 (e.g., E_{max_A}+Q_{max_A}+E_{max_B}+Q_{max_B}=T_{alloc}).

The values Qₘₐₓ and Eₘₐₓ set for different request controllers 312 be selected/tuned through experimentation. For example, referring to the example of FIG. 3, it may be found that concurrently servicing fifty (50) requests of type “X” results in optimal throughput, whereas concurrently servicing twenty (8) requests of type “Y” and “Z” is optimal.

In some cases, threads may be borrowed/shared between request controllers 312. For example, if class “A” controller 312a has unused/idle threads and class “B” controller 312b has no available threads, then one or more of the threads allocated to controller 312a may be temporarily utilized to service class “B” requests. Subsequently, if a large number of class “A” requests arrive, the threads may be returned to controller 312a. In some embodiments, threads may be borrowed for only a limited amount of time or to service a limited number of requests, thus preventing resource hogging. Such thread borrowing can be coordinated directly between the request controllers 312 or by request filter 310.

Although FIG. 3 shows servicing threads 316, 318 as being separate from internal queues 314a, 314b, in practice a single pool of threads may be used for both queuing and servicing threads. For example, an API request received from request filter 310 can be initially assigned to an available thread from the pool, and that thread may be paused (i.e., in an inactive state). At this point, the request may be considered to be within the internal request queue 314a. At some later time, and according to the configured quotas, the request's thread may be executed (i.e., transitioned to an active state), at which point it may be treated as one of the servicing threads 316, 318.

In some embodiments, each request controller 312 may instantiate a semaphore to determine if its execution quota, Eₘₐₓ, has been reached and, thus, whether a newly arriving request or an enqueued request can be serviced (i.e., moved from an inactive state to an active state). For example, at startup, the request controller 312 can instantiate a semaphore with Eₘₐₓ permits, where Eₘₐₓ is the maximum number of requests that can be serviced concurrently by that particular request controller. If, at any given point in time, the semaphore has available permits, then one or more newly arriving requests or enqueued requests can be serviced (consuming a commensurate number of permits). Permits may be released/returned to the semaphore as servicing requests complete.

Application server 302 can also include a database 320 configured to store information about API requests received over time (i.e., API request history). For example, database 320 may be configured to store, for a given API request, the time the request was received along with the request type and, in some cases, the designated request class. In some cases, database 320 may also be configured to store information about how the manner in which particular requests were handled (e.g., queued vs. rejected vs. serviced). This information can be used to fine-tune thread allocations. For example if a particular type/class if request is frequently rejected, the number of threads allocated to that type/class can be increased.

In some embodiments, request filter 310 may write to database 320 as requests are pulled out of the external request queue 308 and analyzed. In other embodiments, individual request controllers 312 may write to database 320 as requests are passed from filter 310 and/or after request servicing has completed. In some embodiments, individual request controllers 312 may query database 320 to determine a rate of recent request traffic, and use this information to determine how arriving API requests should be handled, as discussed further below. In more detail, a request controller 312 can query database 320 to determine the number of requests of a particular type/class that have arrived in the past T seconds (e.g., T=5, 10, 15, 30, 60, etc. seconds).

Application server 302 may include various other hardware and software components omitted for clarity. For example, server 302 can include various computing device components described below in the context of FIG. 6.

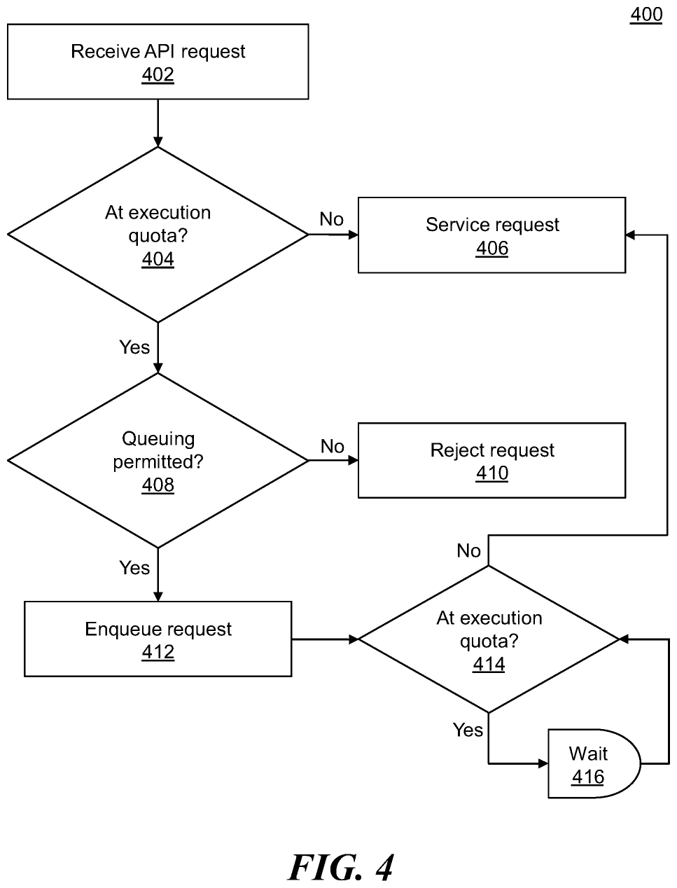

After being passed an API request from request filter 310, the receiving request controller 312 can decide whether the request should be serviced immediately using an available servicing thread 316, queued within internal request queue 314, or rejected. In the first two cases, the request can be assigned to a thread. In the latter case, no thread is consumed. A request controller 312 can utilize various factors and configuration settings in deciding how to handle a newly received API request. For example, the request controller 312 can consider current load on application server 302 and/or downstream resources 306, the number of threads currently enqueued compared to Qₘₐₓ, the number of threads currently executing compared to Eₘₐₓ, along with a rate of recent request traffic. FIG. 4 shows a detailed process that can be used by a given request controller 312 to determine how to handle an incoming API request.

While only two classes of requests and two corresponding request controllers 312a, 312b are shown in the example of FIG. 3, the structures and techniques disclosed herein can be used with generally any number of classes and requests controllers. For example, to optimize throughput of a particular type of API request, a dedicated controller 312 may be instantiated and request filter 310 may be configured to pass only those types of requests to that controller. This allows fine-grained tuning of operations associated with particular requests. The various request controllers 312 can instantiated and configured at application startup according to a configuration file/database.

In some embodiments, multiple levels of request controllers can be used. For example, a first-level controller 312 may handle all requests designated within the same class, whereas two or more second-level controllers (not shown) may be used to handle different types of requests within that same class. A servicing thread 318 of the first-level controller 312 may configured to filter and pass requests to an appropriate one of the second-level controllers based on the request types (i.e., it may function similar to request filter 310). Different second-level controllers may be allocated different numbers of threads, thereby allowing further fine-grained tuning of API request handling.

FIG. 4 shows an illustrative process 400 for determining how to handle an incoming API request. Process 400 may be implemented within, and performed by, individual ones of request controllers 312 shown in FIG. 3. Thus, for convenience, elements of FIG. 3 are referenced in the following description.

At block 402, an API request can be received. For example, the request may be received from request filter 310 in response to the filter classifying the request and forwarding it to the appropriate request controller.

At block 404, a determination can be made as to whether the request controller 312 is at (or above) its execution quota, Eₘₐₓ. For example, at startup, the request controller can instantiate a semaphore, specifying the number of permits to be Eₘₐₓ. If, at a given point in time, the semaphore has an available permit, then the request controller 312 is said to be below its quota and a request may be serviced. If the request controller 312 is below its execution quota, then the request can be immediately serviced, at block 406. That is, the API request can be assigned to an available thread and that thread can be immediately executed. Otherwise, process 400 may proceed to block 408.

At block 408, a determination can be made as to whether queuing is currently permitted within the request controller 312. In some embodiments, two conditions must be met for queuing to be permitted.

First, queuing may be permitted only if the rate of recent request traffic is a below a predetermined threshold rate, which can be defined in terms of one or more configuration settings. A history of arriving requests can be recorded (e.g., within database 320) to ensure that the system does not allocate resources to process an unacceptable level of traffic for a given class/type of requests or a given downstream resource consumed thereby. In some cases, the threshold rate may be defined in terms of two configuration settings, R and T. Queuing may only be permitted if fewer than R requests of a given class/type have arrived in the last T seconds (or other unit of time). To provide for more flexible traffic patterns (i.e., to allow for occasional bursts of traffic), the value of T may be increased. For example, instead of limiting traffic to a rate of 50 requests per second (R=50, T=1), a more flexible limit of 250 requests per 5 seconds (R=250, T=5) may be used. If more than R requests have arrived in the last T seconds, then the incoming traffic rate is considered to be excessive, and no queuing will be allowed while the system remains in this “overload” state. While in the overload state, arriving API requests may be rejected unless there are available execution permits.

In some cases, the request controller 312 can query database 320 for a count of requests of a given class/type that have arrived in the past T seconds. If this count exceeds R/T, then it can determine that the system is overloaded. In other cases, request controller 312 may track the arrival time of the past R requests and calculate the difference in arrival times between the most recent request and the oldest request. If this difference is less than T, then it can determine that the system is overloaded.

Second, queuing may be permitted only if the number of enqueued requests (i.e., paused/inactive threads) is less than the maximum number of enqueued requests, Qₘₐₓ, configured for the request controller.

If queuing is not permitted (due to either of the aforementioned conditions being false), then the API request may be rejected, at block 410. This may free up resources to process other types of requests. Otherwise, process 400 may continue to block 412. In some embodiments, rejecting an API request may involve returning a response error code to the client 304 that submitted the API request. For example, in the case of a REST API, an HTTP response with status code 503 may be returned.

At block 412, the API request may be added to an internal request queue 314. For example, the request can be assigned to a thread that is paused. On a periodic, continuous, or interrupt-drive basis, process 400 can determine whether the request controller 312 is at (or above) its execution quota, Eₘₐₓ, at block 414. If so, then the request's thread may continue to wait, at block 416. Otherwise, the thread may be executed to service the request, at block 406.

In some embodiments, requests may wait in the internal request queue 314 up to a maximum amount of time (which may also be defined as a configuration setting). Requests in the queue for longer may timeout, freeing up a thread for subsequent requests.

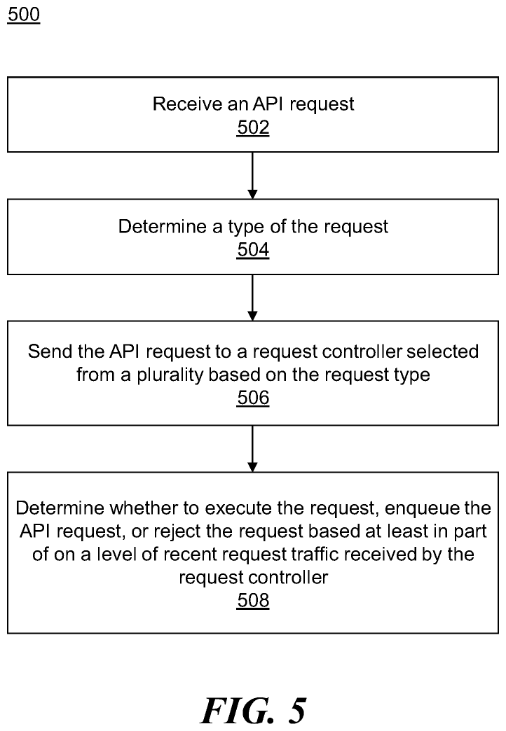

FIG. 5 shows illustrative process 500 for that can be implemented within, and performed by, application server 302 of FIG. 3. For convenience, elements of FIG. 3 are referenced in the following description.

At block 502, a request can be received by an application programming interface (API) of a server device. The servicing of the request may involve use of one or more resources external to the server. In some embodiments, this can include enqueuing the request within low-level “external” request queue 308.

At block 504, a type of the request can be determined. For example, request filter 310 can analyze a header of the request to determine its type, using any of the techniques disclosed previously in the context of FIG. 2 or 3.

At block 506, the request can be sent (or “passed”) to a particular request controller selected from a plurality of request controllers 312 based on the determined request type. Different requests controllers may be configured to service different types/classes of API requests.

At block 508, the request controller, having received the API request, can determine how to handle the request. For example, the request controller can determine whether to immediately service the request, to enqueue the request, or to reject the request. Various factors and techniques for making this decision are disclosed above in the context of FIGS. 3 and 4. For example, the determination can be made at, at least in part, upon a rate of recent request traffic received by the request controller. In some embodiments, this can include enqueuing the request with an “internal” request queue 314 associated with the request controller.

In some embodiments, block 508 can include assigning the request to a thread allocated by/for the request controller (e.g., a service thread 316, 318 or a thread associated with an internal queue 314). In some embodiments, the request controller may be configured to have a maximum number of threads for servicing requests and a maximum number of threads for enqueuing threads. Different request controllers may have different such maximums configured.

Disclosed structures and techniques can increase the throughput of API request handling in client-server systems without requiring additional server or load balancer hardware, thus making them suitable for single-server and embedded environments. Disclosed embodiments can be used in conjunction with a JEE application server framework by, for example, working within the constraints that it imposes (limited view of the request queue, threading control restrictions, etc.). Disclosed embodiments are applicable to various types of client-server systems and applications that provide APIs, including but not limited to storage systems.

FIG. 6 shows an illustrative server device 600 that may implement various features and processes as described. The server device 600 may be implemented on any electronic device that runs software applications derived from compiled instructions, including without limitation personal computers, servers, smart phones, media players, electronic tablets, game consoles, email devices, etc. In some implementations, the server device 600 may include one or more processors 602, volatile memory 604, non-volatile memory 606, and one or more peripherals 608. These components may be interconnected by one or more computer buses 610.

Processor(s) 602 may use any known processor technology, including but not limited to graphics processors and multi-core processors. Suitable processors for the execution of a program of instructions may include, by way of example, both general and special purpose microprocessors, and the sole processor or one of multiple processors or cores, of any kind of computer. Bus 610 may be any known internal or external bus technology, including but not limited to ISA, EISA, PCI, PCI Express, NuBus, USB, Serial ATA or FireWire. Volatile memory 604 may include, for example, SDRAM. Processor 602 may receive instructions and data from a read-only memory or a random access memory or both. The essential elements of a computer may include a processor for executing instructions and one or more memories for storing instructions and data.

Non-volatile memory 606 may include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 606 may store various computer instructions including operating system instructions 612, communication instructions 614, application instructions 616, and application data 617. Operating system instructions 612 may include instructions for implementing an operating system (e.g., Mac OS®, Windows®, or Linux). The operating system may be multi-user, multiprocessing, multitasking, multithreading, real-time, and the like. Communication instructions 614 may include network communications instructions, for example, software for implementing communication protocols, such as TCP/IP, HTTP, Ethernet, telephony, etc.

Peripherals 608 may be included within the server device 600 or operatively coupled to communicate with the server device 600. Peripherals 608 may include, for example, network interfaces 618, input devices 620, and storage devices 622. Network interfaces may include for example an Ethernet or Wi-Fi adapter. Input devices 620 may be any known input device technology, including but not limited to a keyboard (including a virtual keyboard), mouse, trackball, and touch-sensitive pad or display. Storage devices 622 may include one or more mass storage devices for storing data files; such devices include magnetic disks, such as internal hard disks and removable disks; magneto-optical disks; and optical disks.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high-level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate. The program logic may be run on a physical or virtual processor. The program logic may be run across one or more physical or virtual processors.

The subject matter described herein can be implemented in digital electronic circuitry, or in computer software, firmware, or hardware, including the structural means disclosed herein and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or another unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this disclosure, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of nonvolatile memory, including by ways of example semiconductor memory devices, such as EPROM, EEPROM, flash memory device, or magnetic disks. The processor and the memory can be supplemented by, or incorporated in, special purpose logic circuitry.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described in connection knowledge of one skilled in the art to affect such feature, structure, or characteristic in connection with other embodiments whether or not explicitly described.

The disclosed subject matter is not limited in its application to the details of construction and to the arrangements of the components set forth in the following description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

All publications and references cited herein are expressly incorporated herein by reference in their entirety.

1. A method comprising:
receiving a request by an application programming interface (API) of a server device, wherein servicing of the request involves use of one or more resources external to the server;
determining, by a filter of the server device, a type of the request;
sending, by the filter, the request to a controller selected from a plurality of controllers of the server device based on the request type, where different ones of the plurality of controllers are configured to service different types of API requests; and
determining, by the controller, how to handle the request as one of:
servicing the request,
enqueuing the request, or
rejecting the request,
wherein the determining of how to handle the request is based at least in part upon a rate of recent request traffic received by the controller.

2. The method of claim 1, wherein the receiving of the request includes enqueuing the request in a first queue, wherein the determining of how to handle the request includes enqueuing the request in a second request queue of the controller.

3. The method of claim 1, wherein the determining of how to handle the request includes assigning the request to a thread of the controller.

4. The method of claim 3, wherein the controller is configured to have a maximum number of threads for servicing requests and a maximum number of threads for enqueuing threads.

5. The method of claim 4, wherein another controller of the plurality has a maximum number of threads for servicing requests different from that of the controller.

6. The method of claim 1, wherein the server device is part of a storage system.

7. The method of claim 1, wherein the server device is part of a storage array.

8. A server device comprising:
a processor; and
a non-volatile memory storing computer program code that when executed on the processor causes the processor to execute a process including:
receiving a request by an application programming interface (API) of the server device, wherein servicing of the request involves use of one or more resources external to the server;
determining, by a filter of the server device, a type of the request;
sending, by the filter, the request to a controller selected from a plurality of controllers of the server device based on the request type, where different ones of the plurality of controllers are configured to service different types of API requests; and
determining, by the controller, how to handle the request as one of:
servicing the request,
enqueuing the request, or
rejecting the request,
wherein the determining of how to handle the request is based at least in part upon a rate of recent request traffic received by the controller.

9. The server device of claim 8, wherein the receiving of the request includes enqueuing the request in a first queue, wherein the determining of how to handle the request includes enqueuing the request in a second request queue of the controller.

10. The server device of claim 8, wherein the determining of how to handle the request includes assigning the request to a thread of the controller.

11. The server device of claim 10, wherein the controller is configured to have a maximum number of threads for servicing requests and a maximum number of threads for enqueuing threads.

12. The server device of claim 11, wherein another controller of the plurality has a maximum number of threads for servicing requests different from that of the controller.

13. The server device of claim 8, wherein the server device is part of a storage system.

14. The server device of claim 8, wherein the server device is part of a storage array.

15. A non-transitory machine-readable medium encoding instructions that when executed by one or more processors cause a process to be carried out, the process comprising:
receiving a request by an application programming interface (API) of a server device, wherein servicing of the request involves use of one or more resources external to the server;
determining, by a filter of the server device, a type of the request;
sending, by the filter, the request to a controller selected from a plurality of controllers of the server device based on the request type, where different ones of the plurality of controllers are configured to service different types of API requests; and
determining, by the controller, how to handle the request as one of:
servicing the request,
enqueuing the request, or
rejecting the request,
wherein the determining of how to handle the request is based at least in part upon a rate of recent request traffic received by the controller.

16. The non-transitory machine-readable medium of claim 15, wherein the receiving of the request includes enqueuing the request in a first queue, wherein the determining of how to handle the request includes enqueuing the request in a second request queue of the controller.

17. The non-transitory machine-readable medium of claim 15, wherein the determining of how to handle the request includes assigning the request to a thread of the controller.

18. The non-transitory machine-readable medium of claim 17, wherein the controller is configured to have a maximum number of threads for servicing requests and a maximum number of threads for enqueuing threads.

19. The non-transitory machine-readable medium of claim 18, wherein another controller of the plurality has a maximum number of threads for servicing requests different from that of the controller.

20. The non-transitory machine-readable medium of claim 15, wherein the server device is part of a storage system.
